(19) United States
(12) Patent Application Publication
(10) Pub. No.: US 2022/0075047 A1
(43) Pub. Date: Mar. 10, 2022

(54) RADAR SENSOR FOR FACTORY AND LOGISTICS AUTOMATION

(71) Applicant: VEGA Grieshaber KG, Wolfach (DE)

(72) Inventors: Roland WELLE, Hausach (DE); Daniel SCHULTHEISS, Hornberg (DE)

(73) Assignee: VEGA Grieshaber KG, Wolfach (DE)

(21) Appl. No.: 17/422,975

(22) PCT Filed: Feb. 18, 2020
(86) PCT No.: PCT/EP2020/054226

§ 371 Date: Jul. 14, 2021

(30) Foreign Application Priority Data
Feb. 18, 2019 (DE) 10 2019 202 144.1

(51) Int. Cl. G01S 13/34; G01S 17/86

(52) U.S. Cl. CPC G01S 13/341; G01S 17/86

(57) ABSTRACT

A radar sensor for factory and logistics automation is provided, including: a radar circuitry including a radar chip, configured to generate, emit, receive, and evaluate radar measurement signals; and a housing in which the radar circuitry is located and in which the radar chip has a cross-sectional area of less than 1 cm², the radar measurement signals having a frequency above 160 GHz and being focused such that a resulting beam aperture angle is less than 5°.

### REFERENCE TO RELATED APPLICATIONS

The present application claims the priority of German patent application no. 10 2019 202 144.1, filed Feb. 18, 2019, which is incorporated herein by reference in its entirety.

### FIELD OF THE INVENTION

The invention relates to factory and logistics automation. In particular, the invention relates to a radar sensor for factory and logistics automation, the use of such a radar sensor to replace an optical sensor in the field of factory and logistics automation, and the use of such a radar sensor to replace a light barrier laser sensor.

### BACKGROUND

In factory and logistics automation, optical sensors are used to measure distance or angle values, for example. Other examples of applications are rotation rate sensors or sensors for detecting the presence of personnel. These optical sensors can, for example, be designed in the form of a light barrier to detect whether a person is approaching a danger zone.

### SUMMARY

It is an object of the invention to provide a cost-effective alternative to known optical sensors, and in particular to light barriers.

This object is solved by the features of the independent patent claims. Further embodiments of the invention are set forth in the dependent claims and the following description of embodiments.

A first aspect relates to a radar sensor for factory and logistics automation. The radar sensor comprises a radar circuit arrangement or circuitry with a radar chip configured to generate, emit, receive and evaluate radar measurement signals. A housing is provided in which the radar circuitry is arranged, wherein the radar chip has a cross-sectional area of less than 1 cm² and the generated radar measurement signals have a frequency of more than 160 GHz, in particular of more than 200 GHz, and are focussed in such a way that the resulting beam aperture angle is less than 5°, or at least less than 10°, in particular even less than 3°.

For example, the radar chip has a cross-sectional area of less than 0.25 cm².

According to one embodiment of the invention, the housing has a width of 2 cm, or less, a height of 5 cm, or less, and a depth of 5 cm, or less.

The height of the housing runs in the direction of measurement, i.e. in the direction in which the radar sensor emits its measurement signal.

For example, the housing has a screw-in thread with a diameter of at most 1.91 cm or 0.75 inch. It may also be envisaged that the housing has a screw-in thread with a diameter of at most 1.27 cm or 0.5 inch.

For example, the housing is cylindrical.

According to a further embodiment, the modulation bandwidth for the modulation of the radar measurement signals generated by the radar circuitry is above 4 GHz, in particular above 10 GHz, in particular 19.5 GHz or 31.5 GHz.

According to one embodiment, the radar sensor is configured to generate and transmit a FMCW signal (Frequency Modulated Continuous Wave Signal).

According to a further embodiment, the frequencies of the generated radar measurement signals are between 231.5 GHz and 250 GHz.

According to a further embodiment, the housing comprises a lens (or two or more lenses connected in series) which is arranged to focus the radar measurement signals emitted and/or received.

For example, the lens has a diameter of 20 mm or less.

According to a further embodiment, the radar circuitry comprises (alternatively or in addition to the housing lens) a (further) lens arranged to focus the radiated radar measurement signals before they hit the housing lens.

For example, this lens has a diameter of 10 mm or less.

For example, it is placed directly on the radiating element of the radar circuit arrangement.

According to a further embodiment, the housing lens has a distance between 5 mm to 50 mm, in particular of 30 mm or less to the radar chip and/or the further lens.

According to a further embodiment of the invention, the radar circuitry comprises a radar chip with an antenna integrated therein, onto which the lens is then placed, if provided.

According to a further embodiment, the radar sensor comprises a communication circuit, wherein the radar sensor is configured to detect changes in the physical measurement measured by the radar sensor in real time and to transmit them via the communication circuit, for example to a remote control unit.

In the context of the disclosure, “real time” means that the changes in the physical measurable variable are reliably detected and set off within a predetermined period of time. In this context, one can also speak of a soft real-time requirement. It must be ensured by the hardware and the software that no undue delays occur which could, for example, prevent compliance with the real-time condition. The processing of the data does not have to be arbitrarily fast; however, it must be guaranteed to be fast enough for the respective application.

According to another embodiment, the radar sensor comprises multiple independent transmit/receive channels and/or multiple radar chips to provide redundancy for safety-critical applications.

According to a further embodiment, the radar sensor comprises a 4 to 20 mA two-wire interface that is set up to transmit the measured values to an external process control system and to receive the energy required to operate the radar sensor.

According to a further embodiment, the radar sensor is configured as a level radar.

In particular, the radar sensor may have a plug connector, set up for ring spanner mounting of the radar sensor in an opening of a container (in which the filling material is located) provided with an internal thread.

A further aspect relates to the use of a radar sensor described above and below to replace an optical sensor in the field of factory and logistics automation, in particular in a safety-critical area such as the automated emergency shutdown of machines or systems.

Another aspect relates to the use of a radar sensor described above and below to replace a light barrier laser sensor.

Further embodiments of the invention are described below with reference to the figures. The illustrations in the figures are schematic and not to scale. If the same reference signs are used in the following description of the figures, these designate the same or similar elements.

### BRIEF DESCRIPTION OF THE FIGURES

FIG. 1 shows a factory installation with radar sensors according to an embodiment.

FIG. 2 shows a logistics automation system according to a further embodiment.

FIG. 3 shows the use of a radar sensor in the field of factory automation and safety technology.

FIG. 4 shows a radar-measuring device of a sorting system.

FIG. 5 shows the basic structure of a radar sensor according to an embodiment.

FIG. 6 shows another embodiment of a radar sensor.

FIG. 7 shows another embodiment of a radar sensor.

FIG. 8 shows another use of a radar sensor.

FIG. 9 shows the use of a radar sensor for factory and/or logistics automation.

FIG. 10A shows a cylindrical radar sensor according to an embodiment.

FIG. 10B shows a radar sensor in cylindrical design according to a further embodiment.

FIG. 11 shows a radar sensor in cylindrical design according to a further embodiment.

FIG. 12A shows a radar sensor with a cuboid housing.

FIG. 12B shows a side view of the radar sensor of FIG. 12A.

FIG. 13A shows a radar safety grid according to an embodiment.

FIG. 13B shows the cascaded construction of a radar safety grid from individual modules.

### DETAILED DESCRIPTION OF EMBODIMENTS

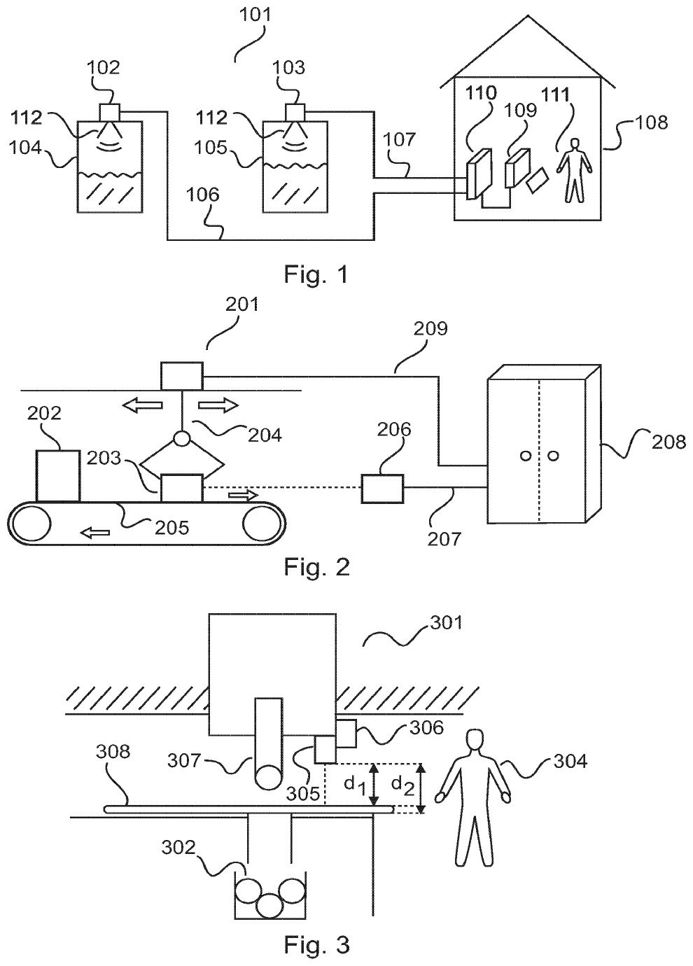

FIG. 1 shows a factory with two radar sensors 102, 103 according to an embodiment. By moving to radar frequencies above 200 GHz and integrating the antennas on the radar chip, a miniaturised, low-cost measurement system can be provided which can meet all the requirements of factory and/or logistics automation, and can thus replace existing optical sensors with their known disadvantages.

In particular, a radar-based measuring device 102, 103 is provided, which is capable of replacing a large part of the optical sensors previously used in the field of factory and logistics automation. The measuring device can in particular be designed to provide distance or angle values. It can also be designed as a rotation rate sensor, as a sensor for presence detection or as a radar-level measuring device.

By reducing the wavelength of the radar signal through the use of higher frequencies, it is possible to simplify the design of the radar measurement device by including at least one primary radiator on the radar chip.

Whereas radar-based measurement methods could previously only be used in the field of process automation due to the size of the antenna and the size of the circuits, it will be possible in the future to provide small and powerful radar sensors for use in the field of factory automation and/or logistics automation by applying the devices proposed here.

Level measuring devices based on radar have become widespread in the field of process automation in recent years due to the many advantages of radar measurement technology. If the term automation technology is understood to mean the sub-area of technology that includes all measures for the operation of machines and systems without the involvement of humans, then the sub-area of process automation can be understood as the lowest level of automation. The aim of process automation is to automate the interaction of the components of an entire plant in the chemical, petroleum, paper, cement, shipping or mining industries.

For this purpose, a large number of sensors are known, which have been adapted in particular to the specific requirements of the process industry (mechanical stability, insensitivity to contamination, extreme temperatures, extreme pressures). The measured values of these sensors are usually transmitted to a control room, where process parameters such as filling level, flow rate, pressure or density can be monitored and settings for the entire plant can be changed manually or automatically.

FIG. 1 shows an example of such a system 101. The two exemplarily shown process-measuring devices 102, 103 record the filling level of the containers 104, 105 using radar signals. The recorded measured values are transmitted to a control room 108 using special communication links 106, 107.

For the transmission of the measured values via connections 106, 107, both wired and wireless communication standards are used, which have been optimised to meet the specific requirements of process measurement technology (robustness of signal transmission against interference, long distances, low data rates, low energy density due to explosion protection requirements).

For this reason, the measuring devices 102, 103 contain at least one communication unit to support communication standards suitable for the process industry. Examples of such communication standards are purely analogue standards such as the 4.20 mA interface or digital standards such as HART, Wireless HART or PROFIBUS.

In the control room 108, the incoming data is processed by the process control system 110 and visually displayed on a monitoring system 109. The process control system 110 or a user 111 can make changes to the settings based on the data, which can optimise the operation of the entire system 101. In the simplest case, a delivery order to an external supplier is triggered if a container 104, 105 is about to run empty.

Since the costs for the sensors 102, 103 are of secondary importance in the process industry compared to the entire system 101, higher costs can be accepted for optimal implementation of the requirements such as temperature resistance or also mechanical robustness. The sensors 102, 103 therefore have price-intensive components such as radar antennas 112 made of stainless steel. The usual price of a sensor 102, 103 suitable for process applications is therefore usually in the range of several thousand euros. The radar measuring devices 102, 103 known so far in the process industry use radar signals in the range of 6 GHz, 24 GHz or even 80 GHz for measurement, whereby the radar signals are frequency modulated according to the FMCW method in the range of the centre frequencies shown above. It is technically difficult to adapt the antennas 112 to higher modulation bandwidths desired for measurement purposes. Currently, bandwidths up to 4 GHz can be realised by using process-suitable antenna designs 112.

A completely different sub-area of automation technology concerns logistics automation. With the help of distance and angle sensors, logistics automation automates processes within a building or within an individual logistics facility. Typical applications of logistics automation systems are in the area of baggage and freight handling at airports, in the area of traffic monitoring (toll systems), in retail, parcel distribution or also in the area of building security (access control). Common to the examples listed above is that presence detection in combination with precise measurement of the size and location of an object is required by the respective application. Up to now, known radar systems have not been able to meet these requirements, which is why different sensors based on optical principles (laser, LED, cameras, ToF cameras) are used in the known state of the art.

FIG. 2 shows an example of a logistics automation system. Within a parcel sorting system 201, parcels 202, 203 are to be sorted with the help of a sorting crane 204. The parcels enter the sorting system on a conveyor belt 205. With the aid of one or more laser sensors 206 and/or camera sensors 206, both the position and the size of the parcel 203 are determined without contact, and transmitted with the aid of fast data lines 207 to a controller 208, for example a PLC 208, which is usually part of the system 201. Since the transmission of the measured values via the lines 207 is time-critical, but the distances to be bridged are rather in the range of a few metres, fast digital protocols such as Profinet or Ethercat are usually used as transmission standards on the communication channels 207, which, in contrast to the known protocols of process automation, have a real-time capability, i.e. a guaranteed transmission of the data in a predeterminable time. This real-time capability of data transmission, which can be achieved with both wired and wireless communication standards, is the basis for controlling the sorting crane 204 via a control line 209. In contrast to known radar measuring devices, optical sensors 206 enable an exact determination of the size and position of an object 203, since the construction of miniaturised sensors with an extremely small steel aperture angle in the area of the optics does not pose a technical problem. In addition, such systems can also be manufactured at a very low cost compared to process measuring devices.

A third sub-area of automation technology concerns factory automation. Applications for this can be found in a wide variety of industries such as automobile manufacturing, food production, the pharmaceutical industry or generally in the field of packaging. The aim of factory automation is to automate the production of goods by machines, production lines and/or robots, i.e. to let it run without the involvement of humans. The sensors used in this process and the specific requirements with regard to measuring accuracy when detecting the position and size of an object are comparable to those in the previous example of logistics automation. Therefore, sensors based on optical measuring methods are usually used on a large scale in the field of factory automation.

Another field of application for optical sensors concerns safety technology, which includes applications in the field of logistics automation as well as in the field of factory automation. FIG. 3 shows a corresponding example. As soon as human interaction is to be expected in the area of fully or partially automated production or sorting systems, the legislator provides for the installation of suitable protective devices for the automated shutdown of machines and systems. In the present example, the punching machine 301 punches out round shaped parts 302 from a sheet material 303. A worker 304 is responsible for supervising the operation. To prevent the worker from injuring himself when interfering with the machine 301, the machine 301 has a safety light barrier 305 or a safety light curtain 305 which is connected to the machine 301 via a communication line 306. The safety light barrier 305 measures the distance d1, d2 to the underlying object, and can prevent the punch 307 from descending both in the absence of a sheet 303 and if the user 304 accidentally enters the punch area. One of the basic requirements for the safe operation of the system is that the sensor 305 can determine the distance with a high degree of accuracy and reliability in conjunction with an extremely short measuring time in order to reliably detect hazardous situations.

Optical sensors have dominated in the field of logistics automation as well as in the field of factory automation and safety technology. These are fast and inexpensive, and can reliably determine the position and/or distance to an object due to the relatively easy-to-focus optical radiation on which the measurement is based. A significant disadvantage of optical sensors, however, is their increased maintenance requirement, since even in the areas listed above, the sensor can become dirty after a few thousand hours of operation, which massively impairs the measurement. In addition, especially when used in production lines, the measurement can be impaired by oil vapours or other aerosols with mist formation and lead to additional contamination of optical sensors.

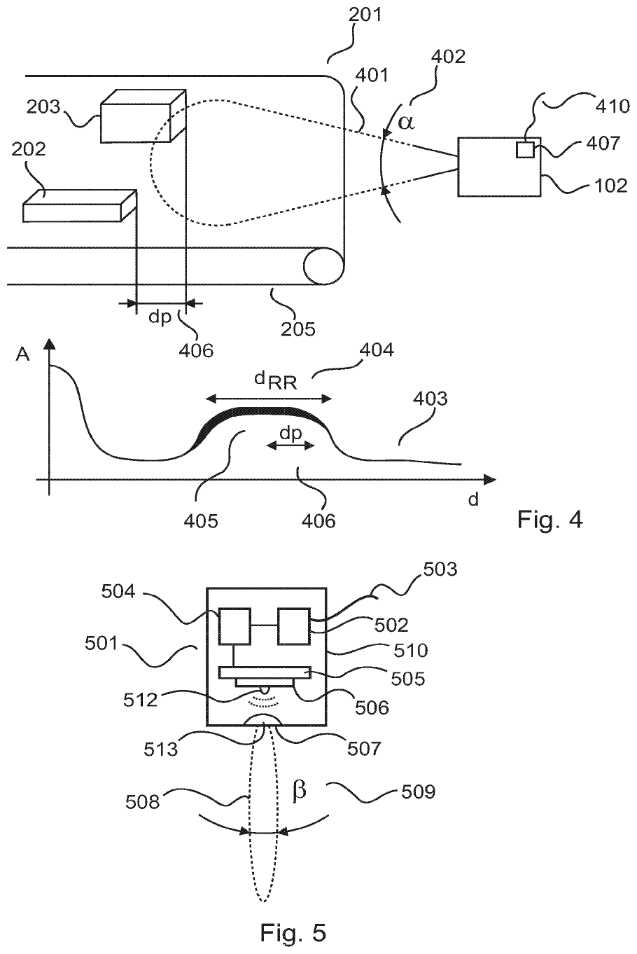

The aforementioned disadvantages can be overcome by using radar-based measuring devices. Before discussing the embodiments in detail, FIG. 4 again summarises the problems to be solved by the present disclosure.

If a known radar measuring device 102 were installed in a sorting system 201 in place of an optical sensor 206, for example, its radar signal 401 would simultaneously detect both parcels 202, 203 located on the conveyor belt 205 at a distance of several metres due to the large aperture angle 402 of typically 8° or more. The detected reflections of the packages are converted into an echo curve 403 by the radar measuring device 102 according to known procedures. If the radar-measuring device 102 operates, for example, at a frequency of 23.5 GHz to 24.5 GHz, the width dRR 404 of a single echo 405 is already 15 cm. If the distance dP 406 of the two packets 202, 203 is less than the radar resolution 404 of the measuring device 102, it can no longer be detected metrologically that two packets are involved. It should be noted that this problem arises due to the widened detection range 402 in combination with the reduced radar resolution 404. Ultimately, even ignoring the aforementioned problems, the use of the radar-measuring device 102 in the sorting system would fail at the latest because the communication device 407 of the measuring device 102 is not capable of transmitting the measured value in real time via the communication channel 410. The aforementioned disadvantages become apparent in the same way when an attempt is made to use the device in the field of safety technology (FIG. 3).

The radar sensors described above and below provide high radar resolution and very good beam focusing in combination with a real-time capable communication device in a miniaturised design at a moderate price.

FIG. 5 shows the basic structure of a radar system which is suitable for use in factory and/or logistics automation or safety technology. The radar measuring device 501 has a housing 510 which contains a communication unit 502, a processor 504 and a high-frequency unit 505. The high-frequency unit 505 has at least one integrated radar chip 506, which can generate and radiate high-frequency signals with a frequency of more than 200 GHz. The radar signals penetrate the housing of the radar sensor 501 at a predefined location 507, wherein the housing of the sensor 501 is designed to be penetrable by electromagnetic waves above 200 GHz at least in the region of penetration. The radar signals 508 are focused by focusing elements or lenses 512, 513 on the integrated radar chip 506 and/or in the region of the penetration 507 and or in the region between the radar chip and the penetration in such a way that the resulting beam aperture angle 509 becomes very small, for example smaller than 5°. The measured values determined by the measuring device are transmitted via a wired or wireless data transmission channel 503 at a high data rate to a local control cabinet 208 or a machine 301. It can be optionally provided that this data transmission is executed in such a way that it is real-time capable, and thus the timely influencing of, for example, a production line or a sorting device or also the timely switching off of a machine before endangering a person can be achieved. Standards such as Profinet, Power over Ethernet, Ethernet, Ethercat or IO-Link can be used here.

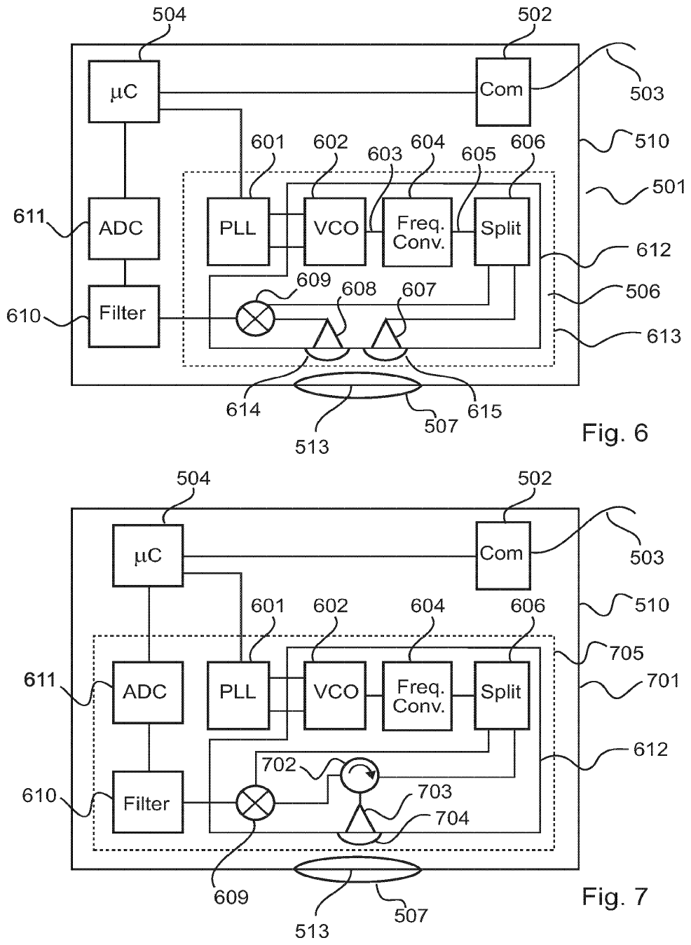

FIG. 6 shows another example of the sensor 501 in detail. The microprocessor 504 controls an integer or preferably fractional division PLL 601. The PLL is in turn connected to a voltage controlled oscillator 602, which in interaction with the PLL outputs at its output 603 a frequency modulated signal with a centre frequency of in the range of 10 GHz to 60 Ghz and a bandwidth between 5 GHz and 10 GHz. The aforementioned parameters can be changed during the operating phase of the measuring device. The signal 603 generated by the VCO is fed to a frequency converter 604, which converts the input signal to a target frequency range of greater than 200 GHz. Usually, several conversion steps are carried out in a cascade, i.e. the frequency of the signal is increased over at least two partial steps by doubling circuits.

However, it is also possible to transmit the signal in the frequency converter to the target frequency range above 200 GHz by single- or multi-stage mixing. The resulting signal 605 is preferably in a range above 200 GHz, frequencies in the range between 230 GHz and 250 GHz have proved particularly advantageous. The signal is then fed to a divider 606, whereupon a portion of the radio frequency signals is radiated outwardly via a primary radiator 607 in the direction of penetration 507. With the aid of a receiving antenna 608, the radar signals reflected in the respective application are detected again, and converted into a low-frequency range in a mixer module 609. The analogue filter 610 and the analogue-to-digital converter 611 capture the signals and feed them to the processor 504 for further processing.

A key idea of the present disclosure is that increased radar resolution 404 can only be achieved by reducing the width of the echoes 405. By increasing the modulation bandwidth to more than 4 GHz, preferably more than 10 GHz or particularly advantageously to 19.5 GHz, it can be achieved that the width of the echoes can be reduced into the millimetre range. Thus, even closely spaced reflectors 202, 203, as they can occur in factory and logistics automation, can be reliably detected by measurement. In terms of circuitry, the implementation of these increased modulation bandwidths can only be mastered cost-effectively if the fundamental frequency of the radar signal is high, preferably above 200 GHz. Since the wavelength of the radar signals on a semiconductor chip then also moves into the millimetre or submillimetre range, common designs for coupler structures or the primary radiator 607 or the receiving antenna 608 can be implemented directly on the semiconductor substrate 612 of the integrated radar chip 613, which enables a low-cost design. In addition, it can be provided to bundle the radiated or received radar signals in the area of the antennas 607, 608 by beam influencing lens elements 614, 615 in order to achieve a reduced aperture angle 509 of the radar signals.

FIG. 7 shows a further embodiment of a radar device for use in factory and/or logistics automation or security technology. The proposed measuring device 701 differs from the previously presented design by the use of a combined transmitting and receiving antenna 703, which is preferably implemented on the semiconductor substrate 612 of the integrated radar chip due to the high operating frequency of more than 200 GHz. An additional transmit/receive switch 702, which is also integrated on the chip 612, serves to separate the signals. Optionally, a reduction of the aperture angle 509 of the measuring device can also be achieved in this case if a beam-influencing lens element 704 is applied directly to the chip in the area of the primary radiator 703. In the present example, it is also envisaged to integrate also the PLL 601, the ADC 611 as well as the analogue filter 610 into the radar chip 705, for example by bonding the different assemblies in a common package 705. It may also be envisaged to integrate the aforementioned assemblies directly on a single semiconductor substrate 612. The latter embodiments lead to a drastic reduction in the cost of building such a system.

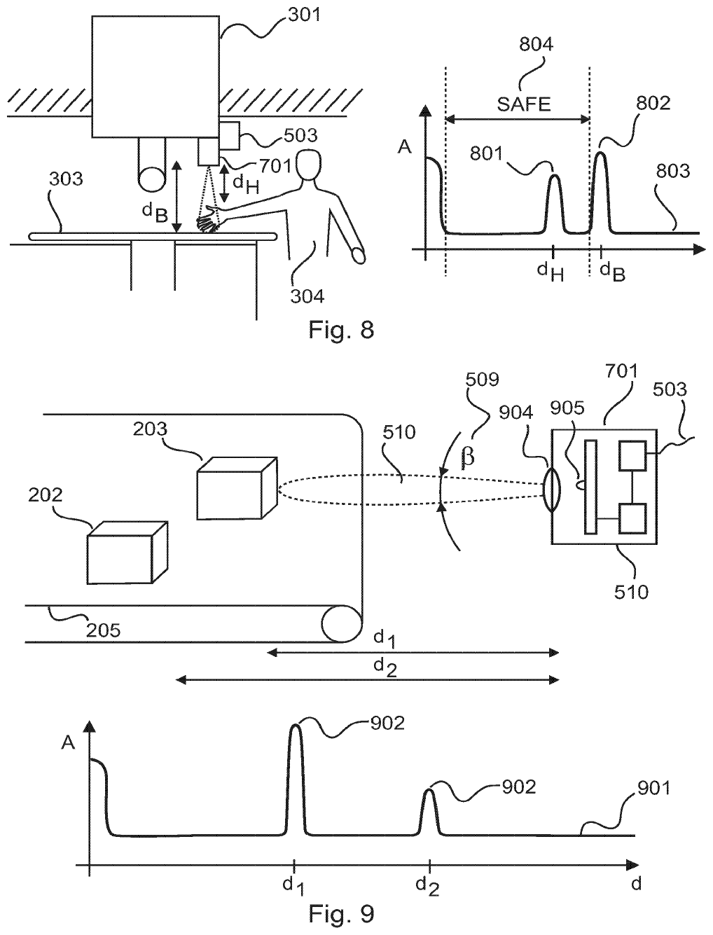

FIG. 8 illustrates the advantages when used in the field of safety technology. The radar measuring device 701 with the aforementioned features monitors the danger zone below the punching machine 301. Due to the extremely high radar resolution of a few millimetres, it is now possible for the first time to detect a corresponding reflection 801 in the echo curve 803 detected by the measuring device 701 when a hand of the user 304 enters the danger zone, and to reliably distinguish this from the reflection 802 of the sheet material 303. In a further embodiment, the measuring device 701 can be equipped by implementing a suitable safety function, for example in the processor 704, in such a way that it monitors at least one parameterisable danger area SAFE 804, and to trigger a targeted, real-time-critical safety reaction when an object is detected in the area. This can be done by transmitting a corresponding signal directly to the machine via the communication device 503. However, it may also be intended to integrate corresponding switching elements, for example positively driven relays, directly in the measuring device 701. Depending on the safety level to be achieved, provision can also be made for multi-channel redundancy of the radar measurement, for example by installing several radar chips in the measuring device 701.

FIG. 9 shows the application of a measuring device described above for factory and/or logistics automation. By using at least two focusing elements 904, 905, the radar signal generated by the measuring device 503 is focused in such a way that it has an aperture angle 509 of a few degrees. This enables the device, by appropriate alignment, to accurately determine the position of a packet 203 along its beam direction 510. By using multiple sensors 701 or by using beam deflecting elements, an extended area of the conveyor belt 205 can also be monitored, and the position and location of the packages 202, 203 can be accurately determined. A sorting system can be efficiently controlled via the fast, real-time communication device 503. The echo curve 901 detected by the measuring device 701 can reliably separate the reflected signals 902, 903 even of closely neighbouring packages 202, 203 due to the high radar resolution of a few millimetres.

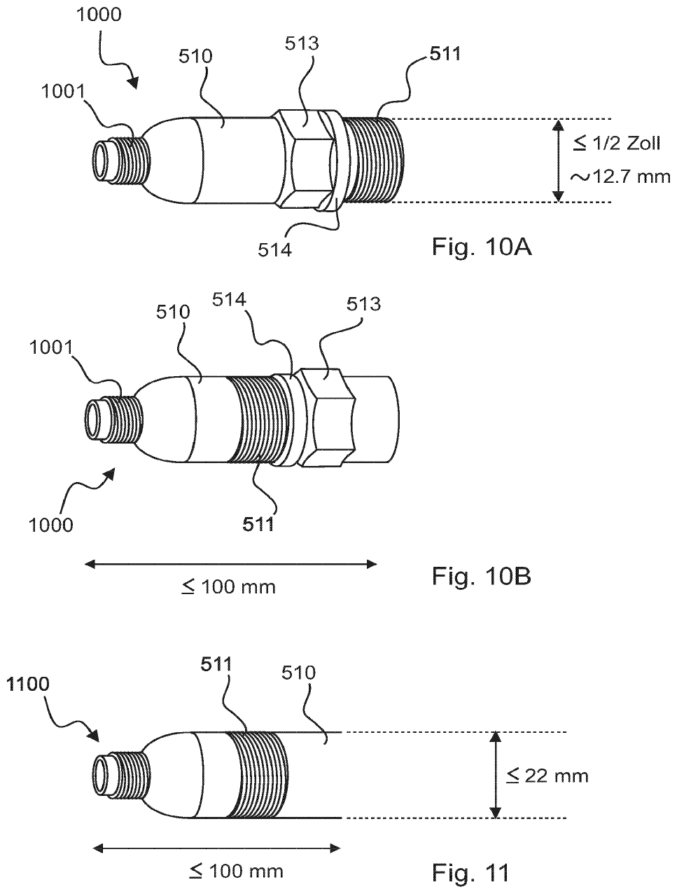

FIG. 10A shows a radar sensor 1000 with a cylindrical housing. An electrical connection is provided at the rear end of the housing 1001, for example for connection to a 4 to 20 mA two-wire line or to an IO-Link interface, the connector of which is screwed onto the rear end of the housing, for example.

The central portion of the housing 510 has a screw-in hexagon 513 followed by a screw-in stop 514, followed by a screw-in thread 511 for screwing into a holder or the opening of a container. The screw-in thread 511 has a diameter of half an inch or less. The screw-in thread may contain, for example, a radar lens and/or the antenna for emitting/receiving the measurement signals.

Typically, the length (or “height”) of the enclosure is a maximum of 100 mm.

The embodiment of FIG. 10B corresponds in many respects to that of FIG. 10A. However, the screw-in thread 511 is located in the middle area of the housing 510, followed by the stop 514 and the screw-in hexagon 513.

In the embodiment according to FIG. 11, a screw-in thread 511 is also provided in the central area of the housing 510, the diameter of the housing being 22 mm. It is possible to screw the radar sensor according to FIG. 11 directly into a threaded receptacle of a machine and to secure it with a lock nut. However, it is also possible to screw the radar sensor into a threaded receptacle of a machine that forms a blind hole. When installed, the front end of the sensor 511 in the area of the radar lens lies flat against a bottom surface of the blind hole of the machine that is permeable to microwave signals. By tightening the sensor in the blind hole, secure fastening can be achieved by bracing against the bottom surface. It may be provided that the sensor 511 has a hexagonal socket to facilitate tightening.

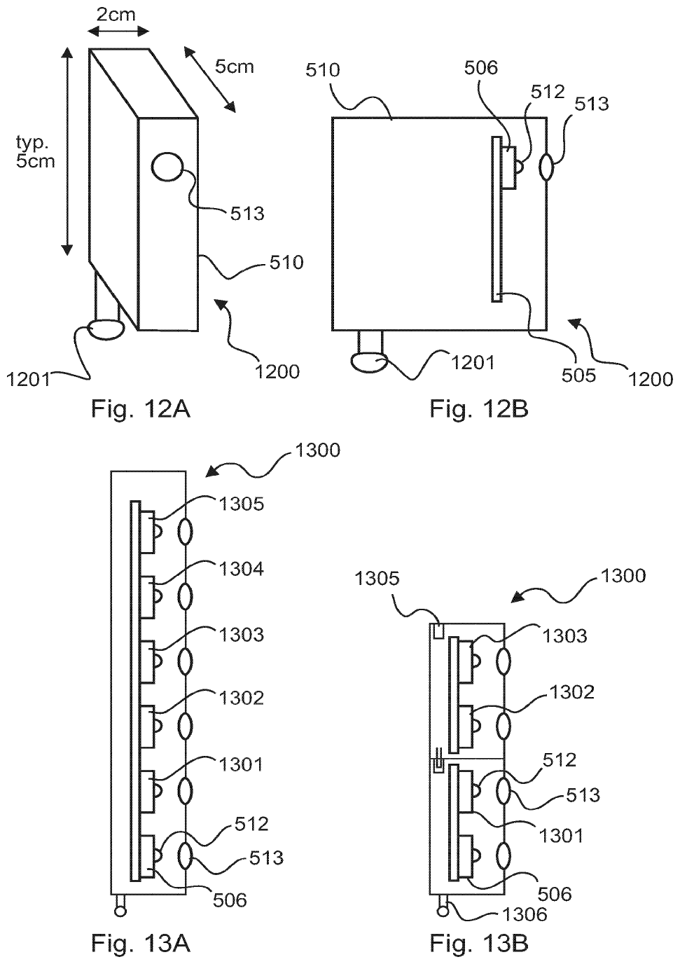

FIG. 12A shows a radar sensor 1200 with a cuboid housing 510. The height of the housing is 5 cm, the width 2 cm and the depth also 5 cm. A lens 513 is arranged in the front area of the housing. An electrical connection 1201 is located in the lower area. The housing is made of polyethylene or polypropylene, for example.

FIG. 13A shows a so-called radar safety grid 1300 comprising a plurality of radar chips 506, 1301 to 1305. Each radar chip has its own first lens 512 located in the area of the radiating element and a “housing” lens 513 located in the beam path of the first lens.

The large number of radar chips provides redundancy, which can be particularly advantageous for safety-critical applications.

FIG. 13B shows a cascaded design of a radar sensor consisting of individual modules. In this embodiment, each individual module has two radar chips 506, 1301 or 1302, 1303, each again with a first lens 512 and a second lens 513 in the housing wall. Each module has an input interface 1305 and an output interface 1306 via which the modules can be electronically interconnected.

With the embodiments described, it is possible for the first time to replace optical measurement methods in the field of factory automation, logistics automation and safety technology with radar-based measurement value acquisition, and thus to reduce the maintenance effort in particular due to the inherent insensitivity of radar measurement technology to contamination. The transition to frequencies above 200 GHz also allows the size and cost of the sensors to be significantly reduced, which means that an adequate replacement for optical sensors can be provided.

In addition, it should be noted that “comprising” and “having” do not exclude other elements or steps and the indefinite articles “a” or “an” do not exclude a plurality. It should also be noted that features or steps described with reference to any of the above embodiments may also be used in combination with other features or steps of other embodiments described above. Reference signs in the claims are not to be regarded as limitations.

1.-19. (canceled)

20. A radar sensor for factory and logistics automation, comprising:
a radar circuitry comprising a radar chip, configured to generate, emit, receive, and evaluate radar measurement signals; and
a housing in which the radar circuitry is located and wherein the radar chip has a cross-sectional area of less than 1 cm²,
wherein the radar measurement signals have a frequency above 160 GHz and are focused such that a resulting beam aperture angle is less than 5°.

21. The radar sensor according to claim 20, wherein the radar chip has a cross-sectional area of less than 0.25 cm².

22. The radar sensor according to claim 20, wherein the housing has a width of at most 2 cm, a height of at most 5 cm, and a depth of at most 5 cm.

23. The radar sensor according to claim 20, wherein the housing has a screw-in thread with a diameter of at most 1.91 cm or 0.75 inch.

24. The radar sensor according to claim 20, wherein a modulation bandwidth for modulation of the radar measurement signals generated by the radar circuitry is above 4 GHz.

25. The radar sensor according to claim 20, wherein a modulation bandwidth for modulation of the radar measurement signals generated by the radar circuitry is 19.5 GHz or 31.5 GHz.

26. The radar sensor according to claim 20, wherein frequencies of the radar measurement signals generated by the radar circuitry are between 231.5 GHz and 250 GHz.

27. The radar sensor according to claim 20, wherein the housing comprises a lens configured to focus the radar measurement signals emitted by the radar circuitry.

28. The radar sensor according to claim 27, wherein the lens has a diameter of 20 mm or less.

29. The radar sensor according to claim 20, wherein the radar circuitry comprises a lens configured to focus the radiated radar measurement signals.

30. The radar sensor according to claim 29, wherein the lens has a diameter of 10 mm or less.

31. The radar sensor according to claim 29, wherein the lens has a distance between 5 mm to 50 mm to the radar chip and/or the lens.

32. The radar sensor according to claim 29, wherein the lens has a distance of 30 mm or less to the radar chip and/or the lens.

33. The radar sensor according to claim 20, wherein the radar chip has an antenna integrated therein.

34. The radar sensor according to claim 20,
further comprising a communication circuit,
wherein the radar sensor is configured to detect changes in a physical measured variable within a predetermined period of time, and to transmit the detected changes via the communication circuit.

35. The radar sensor according to claim 20, further comprising multiple independent transmit/receive channels and/or multiple radar chips configured to provide redundancy for safety critical applications.

36. The radar sensor according to claim 20, further comprising a 4-20 mA two-wire interface configured to transmit measured values to an external process control system and to receive energy required to operate the radar sensor.

37. The radar sensor according to claim 20, the radar sensor being configured as a level radar.

38. The radar sensor according to claim 20, further comprising a connector configured for ring spanner mounting of the radar sensor in an internally threaded opening of a container.

39. The radar sensor according to claim 20, wherein the radar sensor is configured to replace an optical sensor in the field of factory and logistics automation, including automated emergency shutdown of machines or systems, or to replace a light barrier laser sensor.
